(19) United States
(12) Patent Application Publication
(10) Pub. No.: US 2023/0256412 A1
(43) Pub. Date: Aug. 17, 2023

(54) PLANT EXTRACT BASED ETHYLENE ABSORBER AND A PROCESS FOR PREPARING THE SAME

(71) Applicant: ENVIRON CARE PRODUCTS LLP, Greater Noida (IN)

(72) Inventors: Praful SURANA, Greater Noida (IN); Bhavana SHARMA, Greater Noida (IN); Upama TIWARI, Greater Noida (IN)

(21) Appl. No.: 18/136,891

(22) Filed: Apr. 20, 2023

(30) Foreign Application Priority Data
Sep. 1, 2020 (IN) 202021035283

(51) Int. Cl. B01J 20/22; A23B 7/152; B01D 53/14; A01N 3/02; B01J 20/30

(52) U.S. Cl. CPC B01J 20/22; A23B 7/152; B01D 53/1487; B01D 53/1493; A01N 3/02; B01J 20/3078; B01D 2252/205

(57) ABSTRACT

The present invention relates to a natural plant extract based ethylene absorber and a process for preparing the same for inhibiting the ripening process of fruits, vegetables and flowers in cold storages, warehouses and household refrigerators. The ethylene absorber comprises of emulsifier, herbal oil extract, water and anti-oxidant agent combined together in a synergistic ratio. The process for preparing ethylene absorber comprises the steps of preparing solution by mixing distilled herbal oil extract and emulsifier in a beaker; stirring the solution to form a homogenous mixture; preparing a solution by mixing D.I water and anti-oxidant agent; stirring and combining the mixture and solution to form a new solution; dipping molecular sieves in the solution; adding the mixture into solution; soaking the material in the solution for next 60 minutes; and pulling out the material from solution and drying it in air oven.

### FIELD OF THE INVENTION

The present invention relates to a natural plant extract based ethylene absorber and a process for preparing the same for inhibiting the ripening process of fruits, vegetables and flowers in cold storages, warehouses and household refrigerators.

### BACKGROUND OF THE INVENTION

The ripening/ageing of vegetables, fruits and flowers show the distinctive co-ordination of organically synthesized and developmental pathways leading to changes in colour, appearance and nutritional qualities.

The plant hormone ethylene contributes a specific and regulatory role in ripening of many fruits, vegetables and flowers. The warehouse, cold storage industries and household refrigerators are severely affected by ethylene gas in handling and storage of fruits, vegetablesand flowers.

Some conventional methods (adopted by cold storages and warehouses) of lowering temperature and humidity and using different types of gases like nitrogen, sulphur and ozone extend the storage life, maintains the quality and reduce the fungal decay and have various disadvantages like changing the natural properties of fruits, vegetables and flowers to enhancedthe ethylene production.

Most of the existing processes employ hazardous chemicals like potassium permanganate, palladium etc. which is not safe to use. The existing units do not have the properties of deodorization, odour/free ammonia absorption, anti-oxidant and antibacterial.

Accordingly, there remains a need to develop a natural plant extract based ethylene absorber and a process for preparing the same for inhibiting the ripening process of fruits, vegetables and flowers in cold storages, warehouses and household refrigerators. Objects of the invention:

The principal object of the present invention is to overcome the disadvantages of the prior art.

An object of the present invention to provide a natural plant extract based ethylene absorber and a process for preparing the same for inhibiting the ripening process of fruits, vegetables and flowers in cold storages, warehouses and household refrigerators.

Another object of the present invention is to provide a process that uses natural mineral (molecular sieve)/activated charcoal based composition following herbal organic approach as a removal of ethylene gas, bad odour, free-radicals and microbial outgrowth.

Another object of the present invention is to provide a method that absorbs ethylene gas which plays a regulatory role in the ripening of fruits, vegetables and flowers.

Yet another object of the present invention is to provide a process that helps to remove bad odour, ammonia, free-radicals and act as an antibacterial to kill harmful air-borne microorganisms present in the environment.

The foregoing and other objects, features and advantages of the present invention will become readily apparent upon further review of the following detailed description of the preferred embodiment as illustrated in the accompanying drawings.

### SUMMARY OF THE INVENTION

The present invention relates to natural plant extract based ethylene absorber and a process for preparing the same for inhibiting the ripening process of fruits, vegetables and flowers in cold storages, warehouses and household refrigerators. According to an embodiment of the present invention, natural plant extract based ethylene absorber comprises of emulsifier, herbal oil extract, water and anti-oxidant agent combined together in a synergistic ratio.

According to another embodiment of the present invention, the process for preparing natural plant extract based ethylene bsorber composition, comprises the steps of: a) preparing a solution by mixing 15 gm of distilled herbal oil extract, 10 gm of emulsifier in a beaker; b) stirring the solution of step a for 20 minutes @ RT with 500-600 rpm to form ahomogenous mixture is prepared; c) preparing a solution by mixing 65 gm of D.I water, 10 gm of anti-oxidant agent in abeaker; d) stirring the solution of step c for 10 minutes @ RT with 500-600 rpm till it completely dissolved; e) dipping molecular sieves in the solution of step d at RT till the material gets completely dispersed; f) adding the mixture of step b into solution of step e to form an improved solution; g) soaking/exhausting the material in the solution for next 60 minutes; and h) pulling out the material from solution and drying it in air oven at 80° C. for 2 hours.

### BRIEF DESCRIPTION OF DRAWINGS

Embodiments of the disclosure will be described by way of example only with reference to the accompanying drawings, in which:

FIG. 1 illustrates the flow diagram of the present process.

### BRIEF DESCRIPTION OF INVENTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of” consists essentially of,” and the like or the respective closed phrases “consisting of” “consists of the like.

As used herein, the singular forms “a,” “an,” and “the” designate both the singular andthe plural, unless expressly stated to designate the singular only.

In the following description, numerous specific details are set forth in order to provide a thorough understanding of the invention. However, it will be understood by those or ordinary skill in the art that the invention may be practiced without these specific details. In other instances, well known methods, procedures and/or components have not been described in detail so as not to obscure the present embodiment.

The present invention relates to natural plant extract based ethylene absorber and a process for preparing the same for inhibiting the ripening process of fruits, vegetables and flowers in cold storages, warehouses and household refrigerator. The natural plant extract based ethylene absorber comprises of emulsifier, herbal oil extract, water and anti-oxidant agent combined together in a synergistic ratio. wherein the emulsifier may be Tween-80 (Polysorbate 80); herbal oil may be tea-tree oil; a anti-oxidant agent may be Ascorbic acid.

A growth of mold and bacterial colonies from biological deposits on the surfaces which generally break down the protein and producing bad odours. It has functionalities to remove bad odour from the environment and also has very good adsorptive property to remove ethylenegas which is the major concern in specified areas. Apart from that it also has tendency for catching elements of ammonia, free-radicals and VOCs. The method remove ethylene gas, badodour, free-radicals and microbial-outgrowth.

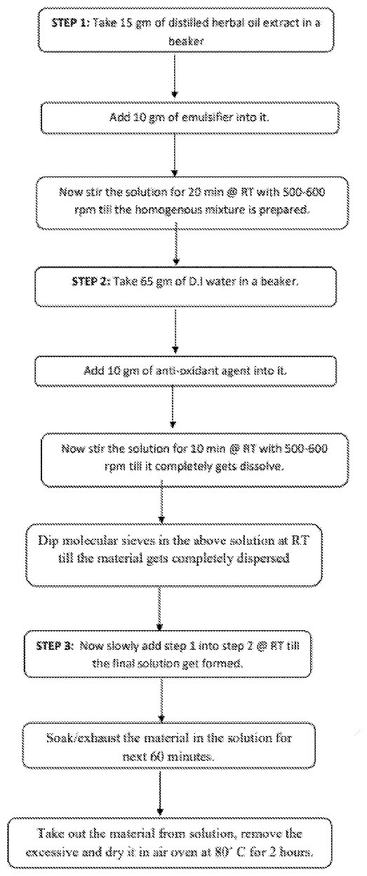

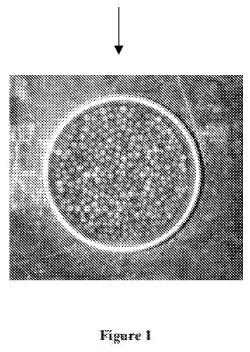

The process for preparing natural plant extract based ethylene absorber composition, comprises the steps of; a) preparing a solution by mixing 15 gm of distilled herbal oil extract, 10 gm of emulsifier in a beaker; b) stirring the solution of step a for 20 minutes @ RT with 500-600 rpm to form a homogenous mixture is prepared; c) preparing a solution by mixing 65 gm of D.I water, 10 gm of anti-oxidant agent in a beaker; d) stirring the solution of step c for 10 minutes @ RT with 500-600 rpm till it completely dissolved; e) dipping molecular sieves in the solution of step e at RT till the material gets completely dispersed; f) adding the mixture of step b into solution of step e to form an improved solution; g) soaking/exhausting the material in the solution for next 60 minutes; and h) pulling out the material from solution and drying it in air oven at 80° C. for 2 hours. (FIG. 1).

The method is using natural mineral (molecular sieve)/activated charcoal based composition by following herbal organic approach which claims as a removal of ethylene gas, bad odour, free-radicals and microbial outgrowth. The final composition is a sachet form and placed inside the refrigerator, warehouses, cold storages and many more places.

The method absorbs ethylene gas which plays a regulatory role in the ripening of fruits, vegetables and flowers. It also helps to remove bad odour, ammonia, free-radicals and act as an antibacterial to kill harmful air-borne microorganisms present in the environment.

As will be readily apparent to those skilled in the art, the present embodiment may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein.

We claim:

1. A process for preparing a plant extract based ethylene absorber comprising the steps of:
a. preparing a solution A by mixing 15 gms of distilled herbal oil extract and 10 gms of emulsifier in a beaker;
b. stirring the solution A for 20 minutes at the rate with 500-600 rpm to form a homogenous mixture;
c. preparing a solution B by mixing 65 gm of D.I water, 10 gm of anti-oxidant agent in a beaker;
d. stirring the solution B for 10 minutes at rate of with 500-600 rpm till it dissolved completely;
e. dipping molecular sieves in the solution B, till the material gets completely dispersed;
f. adding the mixture of solution A into solution B to form an improved solution C; wherein soaking/exhausting the solution C material in the solution B for next 60 minutes; and pulling out the solution C material from solution B and drying it in air oven at 80° C. for 2 hours.
